(19) United States
(12) Patent Application Publication
(10) Pub. No.: US 2026/0110803 A1
(43) Pub. Date: Apr. 23, 2026

(54) Exoatmospheric Positioning

(71) Applicant: Massachusetts Institute of Technology, Cambridge, MA (US)

(72) Inventors: Ronald Kemp, Cambridge, MA (US); Lucas Arthur, Cambridge, MA (US)

(21) Appl. No.: 18/918,367

(22) Filed: Oct. 17, 2024

(51) Int. Cl. G01S 19/27; G01S 19/23; G01S 19/49; G04F 5/14

(52) U.S. Cl. CPC G01S 19/27; G01S 19/235; G01S 19/49; G04F 5/14

(57) ABSTRACT

Apparatus and methods for robust exoatmospheric positioning are described. Intensity modulated direct detection distance ranging can be used between a space-going craft and reflective satellites for accurate position estimation and guidance of the spacecraft along an intended flight path.

### BACKGROUND

Many space-going craft require position and velocity information to plan and execute maneuvers for orbital insertion, rendezvous, or reentry. While early space missions did not require much precision, modern missions, such as satellite servicing and maintenance, the use of reusable launch vehicles, spacecraft guidance and intercept, and some satellite-to-satellite communications, can benefit from precise positioning and velocity information.

Global Navigation Satellite Systems (GNSS), such as the United States' Global Positioning System (GPS), can be used for precise positioning both on the Earth's surface and in low earth orbit (LEO). However, current GNSS systems use a small number of large, complex, and expensive satellites, which cannot be repaired or promptly replaced, meaning that disabling only a few satellites could disrupt the system over a large area. The long distances involved between satellite and spacecraft and resulting low received power also mean that GNSS is susceptible to signal spoofing and jamming. In some situations, it may become important for governments and commercial entities to seek an alternative method of space navigation that is more robust against interference from adversaries.

An existing alternative to GNSS is the use of ground-based tracking. However, radar and optical signals launched from the ground are subject to atmospheric distortions, which can degrade the positional accuracy of the spacecraft or satellite. Persistent tracking with extended integration times can overcome atmospheric distortions, but this is not suitable for guiding vehicles for short time-scale maneuvers. Additionally, the limited view of a single ground station means that a large network would be required for persistent tracking throughout an orbit or trajectory, and tracking may be unavailable over contested or remote regions of Earth. Ground-based tracking is also subject to disruption. Ground data must be aggregated from a distributed network of stations and transmitted promptly to the vehicle, during which time it may be subject to jamming, spoofing, or other interference.

### SUMMARY

The present disclosure relates to a robust exoatmospheric, position-estimation system for a space-going craft. The system uses ranging from the space-going craft to one or more orbiting, reflective satellites (also referred to as benchmarks). The range estimates can be used for autonomous trilateration by navigational instruments aboard the space-going craft to estimate, with high accuracy, the position of the space-going craft with respect to a reference frame such as an Earth-centered inertial frame. Because the space-going craft may be moving relative to the reference frame, trilateration can involve estimating the trajectory of the space-going craft from a set of ranges to one or more of the benchmarks. Ranging can be done with light detection and ranging (LiDAR) apparatus and methods, though other ranging techniques could be employed such as radar that employs microwaves or radio waves.

This exoatmospheric approach can avoid the use of trans-atmospheric signals, which can be distorted and/or disrupted, and does not depend on GNSS satellite emissions that can be jammed. Ranges to benchmarks can be estimated using time-of-flight range measurements. In space, however, a benchmark's position is time dependent as the benchmark orbits the Earth. To account for movement of the benchmark, the benchmark's location at a point in time (with respect to an Earth frame of reference), referred to as a “fiducial,” can be estimated by a controller on board the space-going craft using orbital ephemerides for the benchmark and a precise clock. The exoatmospheric approach is resistant to disruption because the position-estimation system for the space-going craft is space-based, self-contained, can use signaling frequencies at which the atmosphere is opaque, can be performing ranging measurements in directions away from Earth using angular detection windows that are narrow and changing, and can use from one to a large number of brightly reflecting orbiting objects.

Some implementations relate to navigation instruments for a space-going craft. The navigation instruments can comprise: memory to store ephemerides data for a reflective satellite; a clock to calibrate to a time standard used for determining the ephemerides data for the reflective satellite; a controller to calculate an expected position of the reflective satellite at a target time based on the ephemerides data and time marked by the clock; a radiation source; beam-steering apparatus to direct a transmitted beam from the radiation source to the expected position of the reflective satellite at the target time; and a receiver to receive a reflected signal from the reflective satellite.

Some implementations relate to methods for estimating position of a space-going craft. Such methods can comprise acts of: (a) loading ephemerides data for a plurality of reflective satellites into memory on board the space-going craft; (b) calibrating a clock on board the space-going craft to a time standard used for determining the ephemerides data for the plurality of reflective satellites; (c) calculating, by a controller on board the space-going craft, an expected position of a first reflective satellite of the plurality of reflective satellites at a target time based on the ephemerides data and time marked by the clock; (d) operating, by the controller, a beam-steering apparatus on board the space-going craft to direct a transmitted beam from a radiation source on board the space-going craft to the expected position of the first reflective satellite at the target time; and (e) receiving, with a receiver on board the space-going craft, a reflected signal from the first reflective satellite.

All combinations of the foregoing concepts and additional concepts discussed in greater detail below (provided such concepts are not mutually inconsistent) are part of the inventive subject matter disclosed herein. In particular, all combinations of subject matter appearing in this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1 illustrates an example of an exoatmospheric position-estimation system that includes navigational instruments on board a space-going craft and a plurality of reflective satellites (at least some of which are used as benchmarks).

FIG. 2 depicts an example of navigational instruments that can be used in the exoatmospheric position-estimation system of FIG. 1.

FIG. 3A depicts acts that can be included in a method for navigating a space-going craft.

FIG. 3B depicts acts that can be included in a method for navigating a space-going craft.

### DETAILED DESCRIPTION

### 1. Introduction

The inventors have recognized and appreciated that GNSS navigation systems are susceptible to disruption because of weak signal strengths available in some cases, an antenna configuration that accepts jamming signals that might have greater signal strength than the signal, or trans-atmospheric communication links which are susceptible to distortion, spoofing, and/or jamming. The inventors' exoatmospheric position-estimation system for navigation of space-going craft can be used in addition to, or instead of, conventional GNSS navigation systems during flight of the space-going craft. A space-going craft can be any craft that enters space at some time during its flight. A space-going craft can also travel through at least a portion of Earth's atmosphere during its flight. The exoatmospheric position-estimation system can involve distance ranging to one or more orbiting reflective satellites to accurately track and control the location and flight path of the space-going craft.

### 2. Example of an Exoatmospheric Position-Estimation System

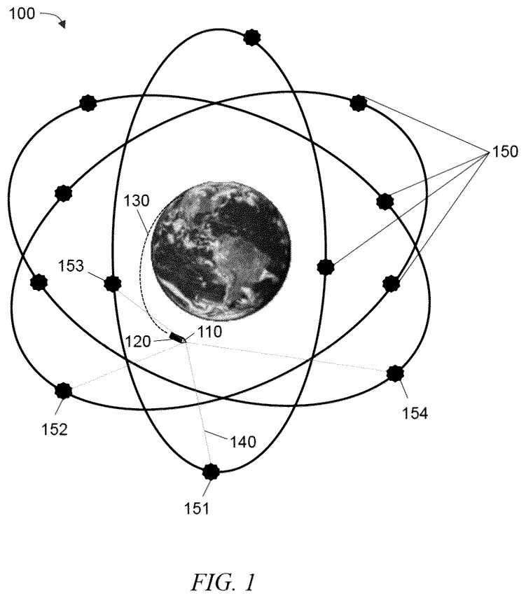

FIG. 1 depicts an example of an exoatmospheric position-estimation system 100. The system comprises navigational instruments 110 that can be mounted on a space-going craft 120 that is intended to travel along a flight path 130. The exoatmospheric position-estimation system 100 utilizes distance ranging to one or more benchmarks 151, 152, 153, 154 from among one or more reflective satellites 150 for estimating the position (along with orientation) of the space-going craft 120. The plurality of reflective satellites 150 can comprise a constellation of reflective satellites (e.g., launched and managed for a particular purpose, such as distance ranging), or can comprise any orbiting satellites for which orbital ephemerides are known that exhibit reflectivity at the wavelengths of electromagnetic radiation used for distance ranging. The plurality of reflective satellites 150 can orbit within the medium earth orbit (MEO) range (5,000 km to 20,000 km above the Earth's surface), the low earth orbit (LEO) range (500 km to 1,200 km above the Earth's surface), or the geostationary equatorial orbit (HEO) range (about 36,000 km above the Earth's surface), though other distances are possible. In some implementations, a first portion of the plurality of reflective satellites 150 can be in one of the orbital ranges (e.g., MEO or LEO), and at least a second portion of the plurality of reflective satellites 150 can be in at least one other of the orbital ranges or another orbital distance. As the space-going craft 120 travels into space, it can employ its onboard navigational instruments 110 to distance range (using LiDAR or microwaves, for example) to one, two, three, four, or more benchmarks 151, 152, 153, 154 within the plurality of reflective satellites 150. The estimated ranges to each benchmark (which can be referenced to fiducials for the benchmarks) can be used to estimate the position (by trilateration or multilateration) of the space-going craft 120 (which can be referenced to an Earth frame of reference) as it moves along its flight path 130.

The benchmarks 151, 152, 152, 154 could be any brightly reflecting object in orbit and may or may not be managed by a single entity. They can be many kilometers away from the space-going craft 120 (e.g., at least 10 km) and located in vastly different directions from the space-going craft (e.g., spanning angles greater than 60 degrees from the direction of travel of the spacecraft). Purpose-built reflecting satellites have the advantage of known geometry, which can allow better deconvolution of the reflected signal received from the satellites for greater positional accuracy. The benchmarks 151, 152, 152, 154 can include small, lightweight retroreflectors, such as corner cubes, which have extremely high cross-sections for reflecting a beam of radiation from the space-going craft 120 back to the space-going craft 120. The corner cubes can be tiled on dedicated spherical satellites, for example, or piggybacked on other satellites which have different primary missions.

There is a tradeoff between using and/or placing the reflective satellites 150 orbiting in LEO or MEO ranges for the inventive exoatmospheric positioning system. Using and/or placing LEO reflective satellites would reduce the power levels but could involve more satellites and ground stations for global coverage. Lower orbital altitudes would also increase the drag on the reflective satellites 150, which could result in more frequent replacement of the satellites and more persistent tracking of each satellite. Errors arising from orbital perturbations from high-order modes in the gravitational field and pressure from radiation reflected by the Earth decrease with increasing orbital altitude. Thus, using the reflective satellites 150 at higher orbital altitudes, such as in MEO, reduces these drawbacks but at the cost of using higher distance-ranging signal strengths, which scale as distance to the fourth power. However, placing the reflective satellites 150 at higher altitudes may make them less susceptible to disturbance by adversarial parties.

The International Laser Ranging Service continuously tracks positions of dedicated reflectors in MEO with millimeter-level accuracy for geodesy and other research purposes (currently available online at https://ilrs.gsfc.nasa.gov). These position determinations, made from a global network of ground stations, are consolidated into ephemerides data with position data reported to millimeter-level accuracy and precision. Because of the extent of historical data, collected since 1976 in the case of the Laser Geodynamic Satellite (LAGEOS), orbits of many reflectors are well-characterized and are updated several times per day. As such, orbital predictions can be accurate to millimeters over a seven-day prediction window. These orbital predictions can be interpolated with Lagrange polynomials to efficiently estimate each reflecting satellite's state vector at any given time, with accuracy in the tens of millimeters.

Radio detection and ranging (RADAR or radar) using radio waves or microwaves, LiDAR using optical waves, or any other time-domain reflectometry apparatus and methods can be used to estimate the range 140 (indicated with a gray dotted line) from the space-going craft 120 to a benchmark 151. Of these systems, a LiDAR-based system is likely to be more robust to interference from off-axis (sidelobe) signals. Some implementations of the exoatmospheric position-estimation system 100 can use intensity modulated direct detection (IMDD) LiDAR for distance ranging.

The range d to a benchmark 151 can be estimated by the signal time-of-flight Δt which, unimpeded by atmospheric effects, is simply:

$$d = \frac{c Δ t}{2} , \qquad ( 1 )$$

where c is the speed of light in a vacuum. The orientation of the space-going craft 120 can be estimated by measuring the sensor orientation that admits a signal. In some instances the orientation estimation can be done with reflected signals from a benchmark 151. In other instances the orientation estimation can be done with astrophysical signals of a known origin. The accuracy of the orientation estimate depends on the angular resolution of the receiving sensor.

If one or more benchmarks 151, 152, 153, 154 are within the field of view and within the transmitter range of the space-going craft 120, range measurements can be performed to estimate distances to the one or more of the benchmarks. Range estimates to one or more fiducials associated with the benchmarks can be determined from the range measurements. A fiducial is the position of a benchmark (e.g., with respect to an Earth frame of reference) at a given point in time. Multilateration with four fiducials can provide a fully-constrained position estimate to update at least a portion of the navigation software's state estimate (estimated position and orientation with respect to one or more locations on Earth) for the space-going craft 120. In some cases, three range estimates are sufficient because the residual ambiguity can be confidently dismissed as inconsistent with the space-going craft's trajectory. In some cases, two range estimates to fiducials can be sufficient. More than four range estimates increase the accuracy of the estimated position.

As may be appreciated, all objects in FIG. 1 (Earth, the plurality of reflective satellites 150, and the space-going craft 120) are moving as the space-going craft 120 travels along its flight path 130. The expected positions of the benchmarks 151, 152, 153, 154 should be calculable during flight of the space-going craft 120. To calculate the expected positions of the benchmarks 151, 152, 153, 154, a set of orbital models for satellites of the plurality of reflective satellites 150 can be loaded into memory accessible by the navigational instruments 110. This loading of orbital models can be conducted just prior to launch in some cases, so that the models are currently accurate. In some implementations, the orbital models can be periodically updated after launch (e.g., for longer missions) via communications with other satellites and/or ground-based stations. The orbital models (stored as ephemerides data) can be established and maintained using ground-based tracking systems and a time standard for the plurality of reflective satellites 150. The ephemerides data and an accurately calibrated, on-board clock (which can be calibrated to the time standard just prior to launch and/or after launch) are used by the exoatmospheric position-estimation system 100 to estimate expected positions of the benchmarks 151, 152, 153, 154. Unlike using ground-based tracking to guide the space-going craft 120, a small number of ground stations can be used for determining orbital ephemerides of the plurality of satellites 150. These ground-based stations can be located in protected territory. In some implementations, no ground-to-space communication is needed with the space-going craft 120 to determine the orbital ephemerides of the plurality of satellites 150 or to otherwise navigate the space-going craft 120 during its flight. The orbital ephemerides, once determined, can then be handed over to the navigational instruments 110 aboard the space-going craft 120, so that the navigational instruments 110 can autonomously estimate the position of the space-going craft 120 by ranging to one or more of the benchmarks 151, 152, 153, 154.

IMDD is a LiDAR approach that can transmit a pseudo-random noise (PRN) sequence and that allows for a highly accurate measurement of signal time-of-flight to and from an object without requiring a frequency-modulated laser or a local oscillator to detect the frequency modulations. However, frequency modulation could be used in some implementations. For IMDD, a photodetector can register the intensity of the returned signal, and the time-of-flight can be estimated by cross-correlating the received signal with the transmitted signal. This approach allows for the disambiguation of multiple returns. Optical intensity modulation at frequencies above 1 GHz and transmitted powers above 100 mW are possible with current technology. As described below, such modulation could be used to achieve nanosecond time-of-flight precision with sufficient power for the ranges over which the laser might operate for an exoatmospheric position-estimation system 100. Transmitted sequences other than PRN are possible, such as a stochastic noise waveform or a frequency chirp, and the invention is not limited to only PRN sequences. The repeating signal that is transmitted should have a base period that is long enough to obtain precise alignment when cross-correlated and have a high enough frequency to suppress timing error.

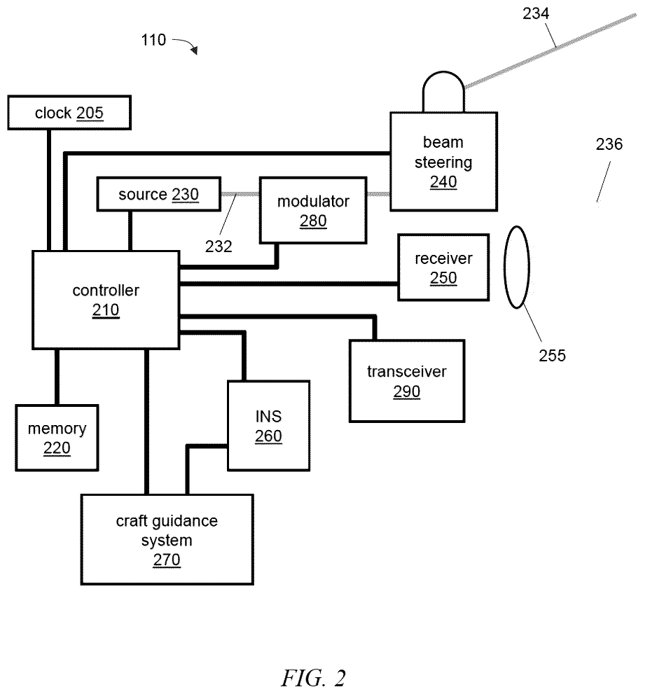

FIG. 2 depicts an example of the navigational instruments 110 that can be included in a space-going craft 120 that implements exoatmospheric positioning. The navigational instruments 110 can comprise a radiation source 230, beam steering apparatus 240, a receiver 250, and a precise clock 205. The navigational instruments 110 can further comprise a controller 210, memory 220, a craft guidance system 270, and an inertial navigation system 260. A modulator 280 may also be included.

In some implementations, the radiation source 230 outputs electromagnetic radiation. The radiation source 230 can comprise a high-power diode laser, diode laser array, or other solid-state or gas laser capable of outputting an amount of optical power in a range from 100 mW to 100 watts. In other implementations, the radiation source 230 comprises a radio wave or microwave generator. In some cases, the wavelength of the radiation source 230 can be absorbed mostly or completely by the atmosphere, such that detection and interference from the ground is significantly inhibited or not possible. In some implementations, the radiation source 230 can be a diode laser capable of outputting approximately 100 mW of optical power and that can be directly gain modulated at speeds up to 1 GHz. If the radiation source 230 cannot be modulated at high speeds with high output power, a modulator 280 can be used to intensity modulate the output radiation 232 from the radiation source 230. The modulator 280 can be arranged to receive the output radiation 232 from the radiation source 230 and modulate the intensity of the output radiation (e.g., to encode a signal provided by the controller 210). The modulator 280 can comprise an electro-optic modulator in some cases.

To exceed the accuracy of GNSS systems, the time-of-flight positioning system should provide meter-scale accuracy for distance ranging estimates outside of the Earth's atmosphere. Meter-scale accuracy would involve nanosecond timing capabilities for the transmission and reception of signals to and from the benchmarks. Nanosecond timing capabilities place constraints on the modulation mechanism used and the signal power levels transmitted to the benchmarks.

For a diffraction-limited signaling system and without being bound to a particular theory, the received power Pᵣ is related to the transmitted power Pₜ by the the cross-section σ of the benchmark 151, the effective collecting area Aₑ of the receiver 250, the distance R or range 140 between the space-going craft 120 and the benchmark 151, the wavelength λ of the transmitted beam, and the beam waist w₀ of the transmitted beam 234:

$${P}_{r} = \frac{4 {P}_{t} {w}_{0}^{2} σ {A}_{e}}{{π}^{2} {R}^{4} {λ}^{2}} . \qquad ( 2 )$$

To determine the received optical power for a LiDAR implementation that would exceed a given signal-to-noise ratio, the expected noise power is estimated. The dominant noise source the system experiences is radiation flux from the background sky. The constant background can be subtracted from the received power; however, the background radiation arriving at the detector follows a Poisson distribution, with an expected variance equal to the background power. Assuming a background flux equivalent to that of a reference magnitude star in the visual band, mᵥ=0, the background flux would be on the order of 10⁻²³ W m⁻² Hz⁻¹, over the 88 nm width of the visual band, corresponding to a background noise level of 10⁻⁹ W m⁻². A commercially available, nanometer-width bandpass filter further suppresses the noise background to 10⁻¹¹ W m⁻². This constant background can be subtracted away, leaving Poissonian fluctuations of 10⁻¹⁶ W, for a 0.01 m² receiver. To overcome the background noise and achieve a signal-to-noise ratio of 10, the optical power received by the receiver 250 should then be greater than 10⁻¹⁵ W.

Following these relationships, the approximate power levels for a 550 nm laser system can be estimated for a set of transmission ranges and reflector cross-sections. Purpose-made retro-reflectors, such as the LAGEOS and Etalon satellites, have measured optical and IR cross sections of 10⁷ m². In contrast, a non-purpose-made reflector might have an 0(1) m² cross section. Assuming a beam waist of 1 cm, and a receiving area of 0.01 m², the power requirements for different distances, corresponding roughly to LEO-to-MEO (5000 km) and LEO-to-LEO (1000 km), are shown in Table 1.

TABLE 1
Power requirements for a 550 nm LiDAR system with a 0.01
m beam waist and a 0.01 m² receiver area with a 10⁶ m² optical
cross section, for a signal-to-noise ratio of 10, and a background of 10⁻⁹ W
m⁻² Hz⁻¹ across the visual band.

| Range (km) | σ (m²) | Pₜ (W) |
|---|---|---|
| 5000 | 1 | 5 × 10⁵ |
| 5000 | 10⁷ | 5 × 10⁻² |
| 1000 | 1 | 7 × 10² |
| 1000 | 10⁷ | 7 × 10⁻⁵ |

For the system to be powered for a flight time of up to one hour by a battery comparable to a standard car battery (approximately 1 kWh) assuming a 10% laser efficiency, the transmitted optical power should be less than 100 W. Table 1 makes clear that such a system is feasible for nearby reflectors or purpose-made reflectors. If the system only needs to operate for ˜10 seconds, which may be adequate for a single course correction to inertial navigation, the optical power could be as high as 104 W, allowing greater distances to the benchmarks.

The output radiation from the radiation source 230 or modulator 280 can be input to beam-steering apparatus 240. For a LiDAR implementation, the beam-steering apparatus 240 (e.g., beam-steering optics) may or may not comprise optics to expand the beam waist of the optical beam from the radiation source 230, such that the optical beam output from the beam-steering apparatus 240 has a beam waist with a value from approximately 0.6 cm to approximately 3 cm, though larger or smaller beam waists can be used in some cases. For the LiDAR implementation, the beam-steering apparatus 240 can further comprise one or more mirrors mounted on commercially available micro-gimbals. The micro-gimbals and mirrors can be in a commercially available beam-steering module, such as the MR-15-30 fast steering mirror available from Optotune of Dietikon, Switzerland. In some implementations, the gimbals can have micro-radian angular resolution and tens of milliseconds or less response times, such as used for deep-space optical communication. The beam-steering apparatus 240 directs a transmitted beam 234 toward a targeted benchmark 151 to estimate the range to the satellite. For a radar implementation, the beam-steering apparatus can comprise a phased array antenna to steer a radio-wave or microwave beam toward the targeted benchmark 151.

To direct the transmitted beam 234 to the targeted benchmark 151, the uncertainty in the vehicle position, vehicle orientation, and in the beam steering mechanics should be less than the beam width of the transmitted beam 234 at the benchmark. For a diffraction-limited beam, the divergence angle of the first Airy disk can be estimated as

$$θ \approx 1.22 \frac{λ}{{w}_{0}} , \qquad ( 3 )$$

where λ is the wavelength of the transmitted beam and w₀ is the beam waist. For a 550 nm wavelength and a 1 cm beam waist, the angular divergence of the transmitted beam 234 would be approximately 10⁻⁴ radians. The microradian angular resolution of beam-steering gimbals and performance of existing inertial guidance systems over timescales of ten days or less would result in combined uncertainties of vehicle orientation and beam steering that are less than 10⁻⁴ radians.

A signal reflected from a benchmark 151 can be received back along the path of the transmitted beam 234 (and separated out with a beamsplitter or circulator) or received at another location on the space-going craft 120 and sent to the receiver 250. Because the reflected beam 236 can be much larger than the transmitted beam 234, a portion of the reflected beam 236 can be received at a separate location from the transmitted beam 234 to increase signal strength and reduce or eliminate signal from the transmitted beam 234 coupling into the receive signal path. A concentrator 255 (e.g., a lens for an optical LiDAR implementation or an antenna (phased array or dish) for a radar implementation) can be used to focus the reflected beam 236 onto at least one detector (photodetector or radio wave amplifier) in the receiver 250. The receiver 250 can convert the received intensity-modulated signal into an electrical signal that can be sent to the controller 210 to cross-correlate with the transmitted signal and estimate the range 140 to the benchmark 151.

The controller 210 can be implemented as logic circuitry in communication with memory 220. The controller 210 can be adapted (e.g., with particular machine-readable instructions stored in memory 220) to execute functionalities described herein and attributed to the controller. In some implementations, the logic circuitry can be implemented as a microprocessor adapted with software and/or firmware code to execute the described functionalities. In some implementations, the logic circuitry can be implemented with logic chips assembled into a logic circuit. More generally, the logic circuitry can be implemented with such devices as a microprocessor, a graphical processing unit (GPU), a microcontroller, a complex programmable logic device (CPLD), a programmable logic device (PLD), a field programmable gate array (FPGA), a digital signal processor (DSP), an application specific integrated circuit (ASIC), logic chips, or some combination of such devices where there can be more than one of any such device in the combination.

The controller 210 can be communicatively coupled to the radiation source 230, the modulator 280, the beam-steering apparatus 240, the receiver 250, the clock 205, memory 220, the inertial navigation system 260, and to the vehicle guidance system 270. The controller 210 can manage operation of each coupled system and estimate the position and orientation of the space-going craft 120 repeatedly to guide the craft along its intended flight path 130. The craft guidance system 270 comprises hardware used to direct the space-going craft 120 along its flight path 130. Such hardware can comprise servos to adjust fins on the craft when traveling through the Earth's atmosphere and/or thrusters to adjust the trajectory and/or orientation of the craft when traveling through space.

As described above, updated ephemerides data for at least some of the plurality of reflective satellites 150 can be loaded onto the memory 220 on board the space-going craft near launch time and/or after launch. After launch of the space-going craft 120, the inertial navigation system 260 can be relied on for vehicle positioning and guidance until the craft approaches LEO altitudes, at which point the exoatmospheric position-estimation system 100 can provide positioning and vehicle guidance in addition to, or in lieu of, the inertial navigation system 260. In some cases, position and orientation data from the inertial navigation system 260 can be periodically corrected using results from the exoatmospheric position-estimation system 100. For reentry through the Earth's atmosphere, the exoatmospheric position-estimation system 100 can hand off position and orientation information to the inertial navigation system 260, which can resume or continue guidance through the atmosphere. The inertial navigation system 260 can comprise accelerometers and gyroscopes.

In some implementations, the navigational instruments 110 can further include a transceiver 290. The transceiver 290 (e.g., a radio-frequency transceiver) can be used for communications to earth-based stations and/or satellites. In some implementations, the transceiver 290 can be used for GNSS navigation (e.g., to receive GNSS signals, estimate a position of the space-going craft 120 based on the GNSS signals, and check the accuracy of the exoatmospheric position-estimation system 100 at locations known to be free from disruptions to the GNSS system). In some cases, the transceiver 290 can be used to request and/or receive updated ephemerides data for one or more of the plurality of satellites 150. The transceiver 290 can also be used for checking the calibration of and/or recalibrating the on-board clock 205.

### 3. Navigational Accuracy

The error in the estimated position of the space-going craft 120 depends on the uncertainty in the measured round-trip time-of-flight to and from the benchmarks 151, 152, 153, 154, and on the accuracy with which the positions of the benchmarks are known. The accuracy of the estimated position of the benchmarks depends, in turn, on the accuracy of the ephemerides data for the benchmarks stored in the memory 220 near launch time and on the error in the absolute time marked by the on-board clock 205.

The error in the estimated distance to the reflective centroid of each benchmark 151, 152, 153, 154 depends on the modulation frequency of the PRN signal. A PRN signal modulated at gigahertz frequencies allows for time-of-flight range measurements with nanosecond precision from point-source reflectors. This contribution to the vehicle's position uncertainty scales linearly with the time-of-flight uncertainty. A 1 ns uncertainty in the time-of-flight corresponds to a 0.15 m uncertainty in the position from a single range measurement. For n pulses, the range uncertainty σₙ can be related to the single-pulse uncertainty σₛₚ by the square root of the number of pulses:

$${σ}_{n} \approx \frac{{σ}_{s p}}{\sqrt{n}} . \qquad ( 3 )$$

For a one-hundred-bit PRN sequence, up to 10⁷ range measurements could be made per second. As few as 10⁵ range measurements could be used to suppress the aleatoric uncertainty to the millimeter scale.

Reflected signals are convolutions of the transmitted signature and the reflector geometry. For well-characterized reflectors (e.g., corner cubes distributed on a spherical surface), the convolution can be known in advance, and the mass centroid can be identified to millimeter accuracy, as demonstrated by the International Laser Ranging Service (ILRS) for geodesy reflectors. Reflectors for which accurate deconvolution is not possible (because the shape of the satellite is not known) produce degraded accuracy in the position estimation of the mass centroid, with errors on the scale of the radius of the reflector.

The absolute locations (e.g., with respect to an Earth frame of reference at a point in time) of the one or more benchmarks in the plurality of reflective satellites 150 are estimated from the loaded ephemerides data, which are used in calculations during flight time, and an accurate clock. Use of the ephemerides database depends on the guidance system maintaining accurate absolute timekeeping, calibrated to the time standard used by the ground tracking system that established the corresponding ephemerides data. The onboard clock 205 could be calibrated to the ground tracking system near launch time (e.g., just before or after) with 10 ns accuracy, matching GPS timekeeping standards. The standard timing could then be maintained during the duration of the flight with the precise clock 205 (e.g., an atomic clock) to keep track of the absolute time common to both the space-going craft 120 and at least some of the plurality of reflective satellites 150 that may be used as benchmarks. In some cases, such as for short missions, a precision quartz oscillator can be used for the on-board clock 205. A local oscillator may or may not be used for measuring time differentials between transmitted and received signals on board the space-going craft 120.

For the absolute-time error contribution to the benchmark's position uncertainty to be below 1 cm for benchmarks at 1000 km altitude, moving along circular orbits at approximately 7.5 km/s, the absolute time obtained by the controller 210 from the on-board clock 205 should be accurate to within 1.33 microseconds with respect to the time standard used for the ephemerides data. Commercially available chip-scale atomic clocks (CSACs) have linear fractional frequency drifts of 2×10⁻⁸ day⁻¹, with Allan deviations of 2.5×10⁻¹¹ at integration times of 250 s and 75 mW power consumption. Commercially available CSACs rated for spaceflight are larger but have Allan deviations of 1×10⁻¹¹ at 1000 s, linear drifts of 1×10⁻¹¹ day⁻¹, and use 120 mW power. NASA's deep space atomic clock (DSAC) demonstrated in 2019 used a 14-liter volume and a 44 W power supply and had an Allan deviation of 3×10⁻¹⁵ at one day with linear fractional frequency drift of 3×10⁻¹⁶ day⁻¹, meeting the microsecond accuracy requirement for 1 cm position error for up to 10 years after launch. The uncertainty in the position of the benchmark is the sum, in quadrature, of the uncertainties in ephemeris data σₑₚₕ for the benchmark and uncertainty in orbital position along the flight path for the benchmark σₜv_{orb}:

$${σ}_{ref} = \sqrt{{σ}_{e p h}^{2} + {( {σ}_{t} {v}_{o r b} )}^{2}} . \qquad ( 4 )$$

The position uncertainty σₚₒₛ for the space-going craft 120 along a line-of-sight direction to the benchmark can then be estimated approximately by summing in quadrature the uncertainty in benchmark position σ_{ref} and the range uncertainty σₙ.

$${σ}_{p o s} \approx \sqrt{{σ}_{ref}^{2} + {σ}_{n}^{2}} \qquad ( 5 )$$

Because σₙ<<σ_{ref}, the overall accuracy of the position estimate would be determined primarily by the quality of the ephemerides and the on-board clock 205. If multiple benchmarks are within view, errors from ephemerides estimates can be further reduced. Overall positional uncertainties should be in the sub-centimeter to decimeter range, depending on the time elapsed since calibration of the clock 205 prior to launch.

An IMDD LiDAR system could be used for exoatmospheric positioning with better than decimeter accuracy on a low power-budget. With monthly clock calibrations and periodic updates to the reflective satellite ephemerides, position estimates could be accurate to 10-20 mm. Without such updates, accuracy could degrade over the course of weeks. Bias drift in the inertial guidance system used to orient the transmitter could interfere with beam-steering after ten days without calibration. With calibration of the beam-steering system, an accuracy better than 1 m would be possible for up to 100 days without recalibration of the onboard clock.

Such a system could provide global coverage and would be resistant and resilient to interference compared to GNSS approaches, meaning that the system would be able to operate in adversarial environments. Because the reflective satellites can be compact and inert, the plurality of reflective satellites 150 could be augmented or replaced promptly and economically if needed. The narrow optical beams traveling between the space-going craft 120 and the benchmarks have strong resistance to side-lobe interference, the ability of jammers to blind the navigation system from off-axis directions. For systems that depend upon a MEO-based plurality of reflective satellites 150, a shroud around the upward-looking (that is, away from the earth) direction of the lens 255 or antenna could mechanically block radiation from from lower-altitude space-going craft or the earth from scattering into the receiver 250, providing immunity to dazzling from bright radiation sources, including the sun. A narrow-band-pass filter used to reject astrophysical light in order to improve signal-to-noise at the receiver would also act as a key, rejecting out-of-band light from jamming sources that do not have prior knowledge of the space-going craft's operational band. Using a frequency that attenuates in the atmosphere could further protect against detection, interception, jamming, and/or spoofing from ground-based systems.

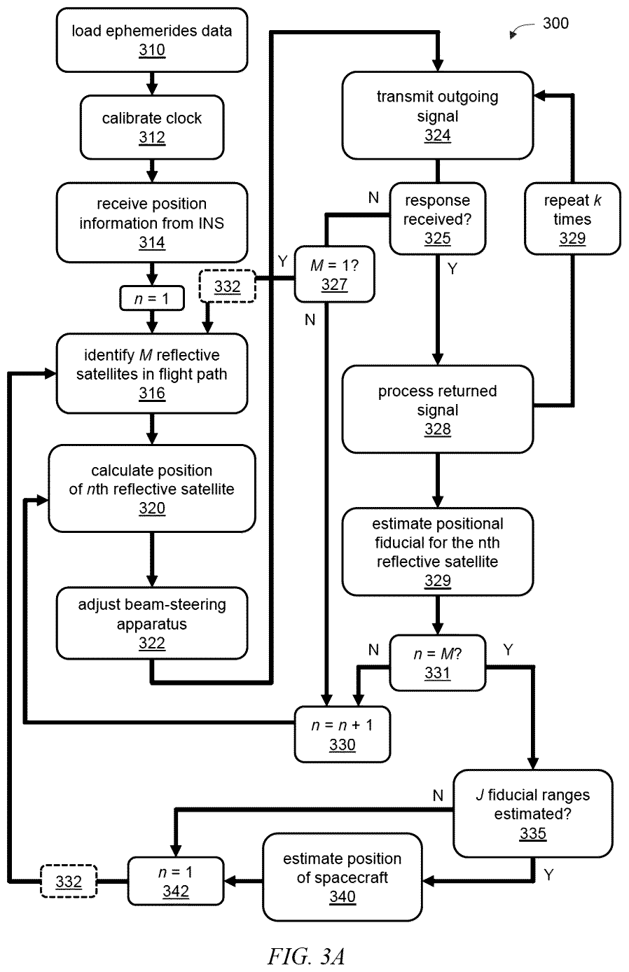

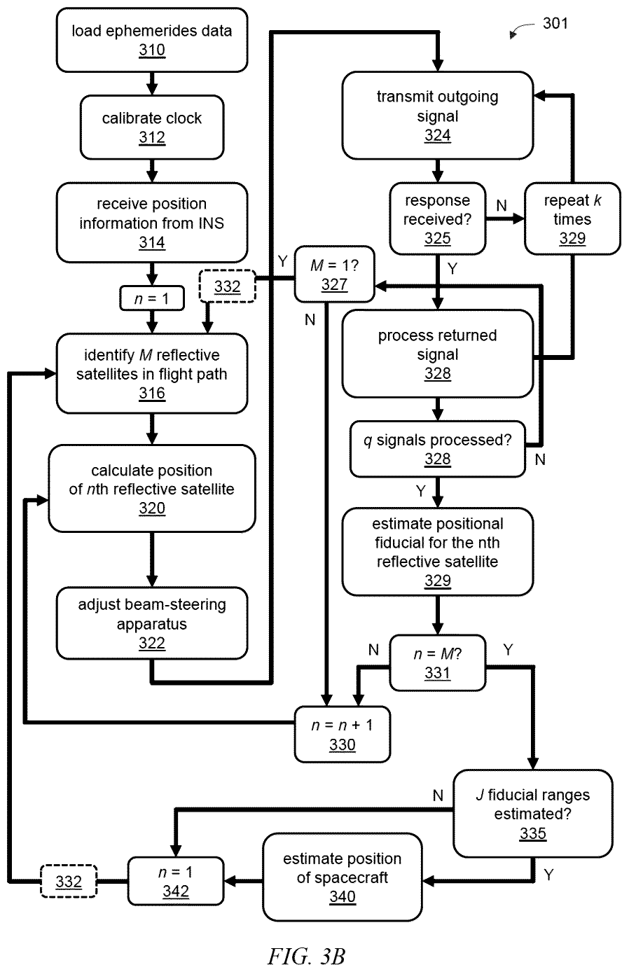

The exoatmospheric positioning system could support a variety of space missions requiring precise position control, including satellite servicing, satellite-to-satellite communication, precision-guided munitions, and reusable launch platform recovery. During a mission, the controller 210 on board the space-going craft 120 can perform at least some or all of the actions which are illustrated in the flow chart of FIG. 3A. The illustrated method 300 is only one example of how the exoatmospheric position-estimation system 100 can be operated; other implementations of the method 300 are possible.

A method 300 for position estimation for a space-going craft 120 with the navigational instruments 110 can comprise loading (step 310) into memory 220 the current and accurate ephemerides data for the plurality of reflective satellites 150 that may be encountered during flight of the space-going craft 120. The corresponding ephemerides data may be used by the navigational instruments 110 for state estimations. The method 300 further comprises calibrating (step 312) the clock 205 on the space-going craft 120 to a timing standard that is used by ground-based stations to determine the ephemerides data for the plurality of reflective satellites 150 that may be interrogated by the space-going craft during flight. For example, the time of the on-board clock 205 can be synchronized or referenced to the running time used by the timing standard. The loading of ephemerides data and calibration of the clock can occur just prior to launch, during launch, or after launch in some cases (e.g., via a radio link or other communication link to the space-going craft 120).

During an initial phase of the flight as the craft passes through the atmosphere and approaches altitudes of LEO, the controller 210 can receive (step 314) position information (e.g., location and orientation of the craft) from the on-board inertial navigation system 260 and/or GNSS signals via transceiver 290 from which the controller 210 can estimate its position and orientation. Based on the estimated position and orientation, and using the ephemerides data, the controller 210 can identify (step 316) M reflective satellites (candidate benchmarks) in the space-going craft's intended flight path 130 that are or will immediately become visible (e.g., unobstructed beam path) to the spacecraft. The number M of reflective satellites can be from 1 to 8 or more, from 1 to 12, from 1 to 20, or from 1 to 40 and may be a subset of a total number of reflective satellites that are or will immediately become visible to the spacecraft. The M reflective satellites may be chosen based on properties favorable to signal processing, such as proximity to spacecraft, wide angular separation between the M reflective satellites, a well characterized satellite geometry (e.g., spherical), and high reflectivity. Choosing a smaller number M of reflective satellites can enable faster updates to position estimates, though possibly at reduced accuracy compared to choosing a larger number of reflective satellites.

The controller 210 can then calculate (step 320) the expected position of an n^{th} benchmark 151 (e.g., n=1) of the M satellites, where n is an integer index that will step through the M satellites (n=1, 2, 3, . . . . M). The calculated position of the n^{th} satellite can be for a target time at which the space-going craft 120 will emit the transmitted beam 234 toward the n^{th} benchmark 151. The calculation (step 320) can be based on the ephemerides data for the n^{th} benchmark 151, the position and orientation of the craft 120, and the target time which will be marked by the clock 205 (which is referenced to the time standard used to generate the ephemerides data for the n^{th} benchmark). After computing the expected position of the n^{th} satellite, the controller 210 can adjust (step 322) the beam-steering apparatus to point a beam of light from the radiation source 230 towards the n^{th} benchmark 151. The controller 210 can then operate the radiation source 230 and modulator 280 (if used) to encode and transmit (324) a signal in the transmitted beam 234 to the n^{th} benchmark 151 at the target time. The transmitted beam 234 reflects back from the n^{th} benchmark and is received by the receiver 250. While emitting the transmitted beam 234, the beam-steering apparatus can scan so that the transmitted beam 234 tracks along the path of the n^{th} benchmark 151. The transmitted signal can be encoded with a PRN sequence. The n^{th} benchmark can be many kilometers away from the spacecraft (e.g., at least 10 km, 50 km, 100 km, 300 km, 500 km, 1000 km or more). The controller 210 can determine whether a response is received (step 325) from the interrogated satellite. If a response is received, the returned signal is processed (step 328). For example, the returned signal is converted to an electrical signal by the receiver 250. The controller 210 or other signal-processing device can then cross-correlate the returned signal, or a processed version of the returned signal, with the transmitted PRN sequence (or other signal sequence used) to estimate the round-trip time-of-flight for the transmitted signal. The processing (step 328) may or may not further involve calculating the range to the n^{th} benchmark 151 based upon the round-trip time of flight (per EQ. 1 above). In some cases, only the round-trip time is used for subsequent calculations. The processing (step 328) can include deconvolving the returned signal based on the geometry of the benchmark.

In some implementations, the steps of transmitting (step 324) the outgoing signal, checking (step 325) for a received response of the returned signal, and processing (step 328) the returned signal from the nah satellite can be repeated multiple (k) times before proceeding to the step of estimating (step 329) position of the space-going craft 120. Repetition of these steps can be used to improve the accuracy of the estimated position.

In some cases, a reflective satellite may not respond (reflect the outgoing signal transmitted by the space-going craft 120). If a satellite does not respond (decision step 325), the controller 210 can check (step 327) whether M=1 (only one reflective satellite was identified (step 316) within the field of view in the flight path). If M=1, then the process flow can return to identifying (step 316) M reflective satellites in the flight path. An optional time delay (step 332) can be implemented to allow more time before attempting the next interrogation of a reflective satellite. As time elapses, more and/or different reflective satellites can come into the field of view of the space-going craft or the same satellite may become more visible. If M is greater than 1, the index n can be incremented (step 330), the position of the next (n+1) satellite calculated (step 320), and the process repeated for the next satellite.

After outgoing signals have been transmitted and returned k times, where k may be any integer from 1 to 1,000,000,000, the controller 210 can estimate (step 329) up to k fiducials for the n^{th} benchmark. The estimated ranges between the space-going craft 120 and the fiducials, obtained from the k transmits (step 324) and subsequent returned signal processing (step 328), can be used to estimate the position of the space-going craft 120 by multilateration. Because time-of-flight values, and therefore ranges, most likely change appreciably with each outgoing signal transmission (since the space-going craft 120 and benchmark 151 are moving with respect to each other), the estimated position of the space-going craft 120 can be based on a set of distinct time-of-flight values and/or ranges at distinct times. The estimated time can be referenced to the time standard used for establishing ephemerides data for the n^{th} benchmark.

After the range to a fiducial has been estimated, the controller 210 can check (decision step 331) whether ranges have been estimated for all M identified reflective satellites. If not, the controller 210 can increment (step 330) to the next (n+1) benchmark 152 and resume at the step of calculating (step 320) the position of the next benchmark.

If ranges have been estimated to or attempted for all M identified reflective satellites, the controller can check (step 335) whether a selected number J of range estimates to J fiducials have been obtained for one or more benchmarks 151, 152, 153, 154. If not, then the controller 210 can reset (step 342) the satellite count index n and resume (after an optional delay (step 332)) at identifying (step 316) M satellites currently visible to the space-going craft 120. The current M satellites may be the same as, different from, or share at least some satellites with the previous M satellites identified by the controller.

If the selected number J of range estimates have been obtained by the controller 210, then the controller can estimate (step 340) a position of the space-going craft 120 based on the J estimates to the J fiducials. Preferably, J is an integer having a value of 4 to 8 or larger to obtain an accurate position estimate. The estimated position, which can be changing because of the movement of the space-going craft 120, can be referenced to any of the times at which ranges to the J fiducials are estimated. The controller can then reset (step 342) the satellite count n and resume (after an optional delay (step 332)) at identifying (step 316) M satellites currently visible to the space-going craft 120. The method 300 can cycle, estimating (step 340) new positions of the spacecraft along its flight path 130 as long as the spacecraft remains in flight and has line-of-sight visibility to reflective satellites. Should the spacecraft re-enter the Earth's atmosphere, the method 300 can terminate and the controller 210 can provide position and orientation information to the inertial navigation system 260, for example, to track position and orientation and provide craft guidance when travelling through the atmosphere.

In some implementations, the method 300 can execute with J having a value less than 4. For example, once a position is estimated, choosing J=1 (obtaining a new range estimate to a single fiducial) can provide useful information to update the previously estimated position.

The method 300 of state estimation illustrated in FIG. 3A can be implemented with fewer than four reflective satellites, though the accuracy of a position estimate for the space-going craft may degrade with a fewer number of satellites, depending on the relative positions and directions of travel of the satellites and the space-going craft. For example, if only one reflective satellite is visible to the space-going craft (M=1), then the method will branch to step 342 from step 335, repeatedly interrogating the same satellite, until J ranges to J fiducials are estimated. In such a case, a time delay (step 332) can be used so that the relative position of the space-going craft 120 and benchmark 151 can change significantly before outgoing signal transmissions (step 324) and estimating (step 329) the range to the next fiducial. A larger angular diversity between fiducials can improve the accuracy of the estimated position of the space-going craft 120.

The value of J and k can be selected dynamically by the controller 210 based on one or more system parameters. For example, if only one reflective satellite is in view of the space-going craft 120, the controller 210 can select a larger value for J and/or k than would be selected if more reflective satellites were in view of the space-going craft 120. Generally, J and k are smaller when a larger number M of reflective satellites exhibiting strong reflected signals are in view of the space-going craft 120 and have a large angular distribution around the space-going craft 120.

The method 300 can be modified at step 325 to retry transmitting (step 324) the outgoing signal instead of branching to step 327. In such an implementation, the branching to step 327 can occur after step 328 and be contingent upon whether a threshold number q of the k transmit attempts resulted in a returned signal that could be processed (step 328). Such a method 301 is depicted in FIG. 3B.

### 4. CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Unless stated otherwise, the terms “approximately” and “about” are used to mean within +20% of a target (e.g., dimension or orientation) in some embodiments, within +10% of a target in some embodiments, within +5% of a target in some embodiments, and yet within +2% of a target in some embodiments. The terms “approximately” and “about” can include the target. The term “essentially” is used to mean within +3% of a target.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. Navigation instruments for a space-going craft, the navigation instruments comprising:
memory to store ephemerides data for a reflective satellite;
a clock to calibrate to a time standard used for determining the ephemerides data for the reflective satellite;
a controller to calculate an expected position of the reflective satellite at a target time based on the ephemerides data and time marked by the clock;
a radiation source;
beam-steering apparatus to direct a transmitted beam from the radiation source to the expected position of the reflective satellite at the target time; and
a receiver to receive a reflected signal from the reflective satellite.

2. The navigation instruments of claim 1, wherein the clock is an atomic clock.

3. The navigation instruments of claim 2, wherein the atomic clock has a linear fractional frequency drift no greater than 2×10⁻⁸ day⁻¹.

4. The navigation instruments of claim 1, wherein the transmitted beam output from the beam-steering apparatus is an optical beam having a beam waist from 0.6 cm to 3 cm.

5. The navigation instruments of claim 1, further comprising:
an inertial navigation system communicatively coupled to the controller to provide position information to the controller during flight of the space-going craft through Earth's atmosphere.

6. The navigation instruments of claim 1, further comprising:
a radio-frequency transceiver to receive Global Navigation Satellite System (GNSS) signals.

7. The navigation instruments of claim 1, wherein the controller is configured to encode a pseudo-random number (PRN) sequence in the transmitted beam.

8. The navigation instruments of claim 7, further comprising:
a modulator to receive the radiation from the radiation source, wherein the controller controls the modulator to encode the PRN sequence as intensity modulations in the transmitted beam.

9. The navigation instruments of claim 7, wherein the controller is configured to:
receive a return signal from the receiver; and
cross-correlate the return signal, or a processed version of the return signal, with the PRN sequence transmitted in the transmitted beam.

10. A method for estimating position of a space-going craft, the method comprising:
(a) loading ephemerides data for a plurality of reflective satellites into memory on board the space-going craft;
(b) calibrating a clock on board the space-going craft to a time standard used for determining the ephemerides data for the plurality of reflective satellites;
(c) calculating, by a controller on board the space-going craft, an expected position of a first reflective satellite of the plurality of reflective satellites at a target time based on the ephemerides data and time marked by the clock;
(d) operating, by the controller, a beam-steering apparatus on board the space-going craft to direct a transmitted beam from a radiation source on board the space-going craft to the expected position of the first reflective satellite at the target time; and
(e) receiving, with a receiver on board the space-going craft, a reflected signal from the first reflective satellite.

11. The method of claim 10, further comprising:
(f) encoding a pseudo-random noise (PRN) sequence in the transmitted beam directed to the expected position of the first reflective satellite;
(g) receiving, by the controller, a return signal from the receiver;
(h) cross-correlating the return signal, or a processed version of the return signal, with the PRN sequence transmitted in the transmitted beam; and
(i) determining at least one of a time-of-flight or a measured range to the first reflective satellite based, at least in part, on a result of the cross-correlating.

12. The method of claim 11, wherein the cross-correlating is done with the processed version of the returned signal, the method further comprising:
deconvolving the returned signal based on a geometry of the first reflective satellite to produce the processed version of the returned signal.

13. The method of claim 11, wherein the encoding is done with a modulator on board the space-going craft, wherein the modulator is arranged to receive an output beam from the radiation source and provide a beam encoding the PRN sequence to the beam-steering apparatus.

14. The method of claim 13, wherein the encoding modulates an intensity of the transmitted beam.

15. The method of claim 11, wherein the first reflective satellite is at a medium earth orbit elevation.

16. The method of claim 11, further comprising:
repeating steps (d) through (i) a plurality of times to determine a plurality of measured ranges to the first reflective satellite; and
calculating a first estimated range to a first fiducial associated with the first reflective satellite based on the plurality of measured ranges.

17. The method of claim 16, further comprising:
repeating step (c) for each of at least a second reflective satellite, a third reflective satellite, and a fourth reflective satellite;
repeating steps (d) through (i) a plurality of times for each of the second reflective satellite, the third reflective satellite, and the fourth reflective satellite to:
calculate a second estimated range to a second fiducial associated with the second reflective satellite;
calculate a third estimated range to a third fiducial associated with the third reflective satellite;
calculate a fourth estimated range to a fourth fiducial associated with the fourth reflective satellite; and
estimate a position of the space-going craft based on the first estimated range, the second estimated range, the third estimated range, and the fourth estimated range.

18. The method of claim 17, further comprising:
providing the position to an inertial navigation system on board the space-going craft for reentry into Earth's atmosphere.

19. The method of claim 10, wherein the clock is an atomic clock.

20. The method of claim 10, further comprising:
receiving, by the controller, position information of the space-going craft from an inertial navigation system on board the space-going craft after launch of the space-going craft for travel through Earth's atmosphere.
